(19) United States
(12) Patent Application Publication
(10) Pub. No.: US 2017/0164274 A1
(43) Pub. Date: Jun. 8, 2017

(54) METHOD AND APPARATUS FOR AUTOMATIC SELECTION OF WIRELESS ACCESS NETWORK

(71) Applicant: COMMISSARIAT A L'ENERGIE ATOMIQUE ET AUX ENERGIES ALTERNATIVES, PARIS (FR)

(72) Inventors: Alexandru PETRESCU, Nozay (FR); Christophe JANNETEAU, Chaudon (FR); Sylvain DECREMPS, Morsang-sur-Oise (FR)

(21) Appl. No.: 15/321,668

(22) PCT Filed: Jun. 12, 2015
(86) PCT No.: PCT/EP2015/063225

§ 371 Date: Dec. 22, 2016

(30) Foreign Application Priority Data
Jul. 9, 2014 (FR) 1456617

(51) Int. Cl. H04W 48/16; H04L 12/26; H04W 76/02; H04W 48/18

(52) U.S. Cl. CPC H04W 48/16; H04W 48/18; H04L 43/16; H04W 76/02; H04W 88/06

(57) ABSTRACT

A method and apparatus for automatically selecting a wireless access network for a mobile device without intervention of the user comprises a method for selecting, according to the location of a mobile device, a connection interface for connecting to a wireless access network. The mobile device is equipped with a plurality of connection interfaces, the method allowing the access networks available at the location of the mobile device to be identified, a plurality ‘n’ of measurements of the quality of the signals for each identified access network to be taken for each connection interface of the mobile device, the ‘n’ measurements to be evaluated, for each connection interface, according to predefined evaluation criteria, and the results of the evaluations to be compared in order to select the connection interface having the best evaluation of the quality of the signal from among the plurality of connection interfaces of the mobile device.

### FIELD OF THE INVENTION

The invention relates to the field of wireless communications and, in particular, pertains to a method and an apparatus allowing a wireless access network to be automatically selected for a mobile device.

### BACKGROUND

Technologies for transmitting data in packets allow a large number of devices to be connected together. The widespread arrival of the Internet, coupled with the massive deployment of mobile devices with impressive storage, computing and communication capabilities, such as smartphones and tablets, provide users—whether stationary, moving, on public transport or in a vehicle—with a wide array of appealing new functions, known as apps. Furthermore, a wide variety of means for connecting to the Internet are available in many locations: WiFi hotspots on campuses, in shopping centers and public parks, 3G and 4G cellular networks in urban areas and along roads and railroads and, recently, networks more specific to vehicular communications—intelligent transport systems (ITS), according to the specifications for implementing local digital networks for wireless connectivity, 802.11p.

A mobile device, whether it is a mobile router or a mobile terminal, is equipped with multiple connection interfaces, each using one connection technology with very different range and signal characteristics, e.g. WiFi, WAVE (wireless access in vehicular environments), 3G and 4G, inter alia.

Accounting for the non-uniformity of access networks, the multiplicity of interfaces of devices, connecting a device to an access network which offers the best connectivity in a given location presents a challenge.

Specifically, a mobile device (mobile router or terminal) is often equipped with multiple communication interfaces with non-uniform characteristics. The characteristics making wireless connection access technologies non-uniform are, for example: (1) whether or not there is a presence indicator signal, or beacon, such as comprised by WiFi yet not by 802.11p; (2) whether the beacon message makes it possible to measure the quality of the signal in the absence of traffic, at short, medium and long range: e.g. WiFi is at short range while cellular is at long range; (3) the domains of values of the signal quality, which may be of different sizes: the quality of the WiFi signal is measured between 0 and 70 on a linear scale, 70 being the best, while for cellular the quality of the signal is measured from 0 to −90 on a non-linear scale, −90 being the best.

Since these devices are commonly moved from place to place, each location in which this device is situated may simultaneously be covered by multiple wireless access networks, with different conditions of use. For example, in a park, WiFi hotspot coverage is concurrent with 4G cellular coverage and the WiFi signal is very strong while the 4G signal is very weak. A mobile device may thus easily attach each of its interfaces to an access network that covers the location in which it is situated, even if the individual conditions of use are not optimum.

However, even if the terminal may simultaneously attach each of its interfaces to an access network, a single interface is used to establish the connections to application servers since one device may only use a single route, referred to as the default route, for its outgoing connections. Thus, in the current state, a single interface is chosen which corresponds to that which was the last to be attached to an access network. This choice criterion, which is trivial, gives random results, and often leads to using the access network which does not offer the best signal quality.

Solutions exist for managing the connection of mobile devices to access networks.

The operating systems currently used on laptop computers, smartphones and tablets make use of automatic connection software. Among those known are, for example, the service referred to as “wlansvc” for the Windows 7® operating system, the “Connection Manager” software for Linux® for desktop computers or else “WiFi Manager” for the Android® operating system for smartphones or tablets. This type of software starts up and attaches each interface to an access network, and functions independently for each interface. The software automatically toggles one WiFi interface between various present WiFi access networks, referred to as ESSID, according to the preferences of the user (order of preference from among all of the ESSIDs, but not with a cellular network; and the associated passwords) and measurements of the signal levels on each ESSID and channel.

However, this type of software has a number of shortcomings when it comes to efficiently and optimally managing the connection to an access network.

Thus, this type of device does not completely take charge of the toggling between interfaces, whether between a WiFi interface and a cellular interface, between two different interfaces, regardless of whether these interfaces are of the same type or of different types.

Although this type of software provides the user with the possibility to define a preference regarding the use of one interface or another, or for the use of a second interface, it does not provide a more refined level of preferences for choosing, for example, between three or more interfaces. The attachment to a cellular network is triggered by a command from the user over the user interface, either upon starting an application requiring an Internet connection, or by explicitly triggering the connection. However, when the connection to the cellular network is lost, subsequent, for example, to leaving cellular coverage, it is necessary to reconnect to the cellular network. However, this type of software does not reconnect to the cellular network when a mobile device returns to the area with cellular coverage. Furthermore, as the connection is triggered by a user action on a user interface, it is not possible for a mobile router without a user interface to connect or reconnect.

Among other limitations, these approaches do not allow automatic toggling to a new interface when the usual interface is no longer available.

In particular, the solution for managing the connection of smartphones allows the WiFi interface of a smartphone to be configured as the “default” interface, and makes it possible to toggle to the cellular interface when the WiFi interface is no longer available. The unavailability of the WiFi interface is confirmed as soon as the WiFi interface is no longer covered by any WiFi access point known to the smartphone. This loss of coverage is confirmed by the absence of reception of WiFi beacon signals for a predetermined period. Thus, a major drawback of this method is that it detects the unavailability of the WiFi interface only belatedly, by waiting for a predetermined period of time to pass in which no WiFi beacon originating from a known WiFi access point is received. In practice, this results in the establishment of any new communication being prevented for this period in which the WiFi interface is kept as the default interface even though it is unavailable, while the cellular interface might be available and therefore usable.

Furthermore, in these known approaches, there is no comparison of the quality of a signal over different networks. Thus, over a WiFi interface, measurements of signals over WiFi channels are periodically taken. These measurements evaluate the the level of reception of the “beacon” messages periodically transmitted by WiFi hotspots. However, certain access networks, which are designed to provide access to mobile routers or terminals moving at high speed, are optimized and do not provide “beacon” signals, and hence do not allow signal measurements of the access network to be taken.

Additional drawbacks of the prior art are that no pre-configuration of known WiFi networks is possible. Specifically, the user must manually enter the parameters to connect thereto on first connecting to a known WiFi access point. These parameters may not be preconfigured in advance. This in particular prevents any use being made of this type of solution on a mobile router which has no user interface, and therefore hinders all first connections to a WiFi access point.

Lastly, it is not possible for a device to remain connected over cellular whenever WiFi access is detected, even if the quality of the WiFi signal is poor or worse than the cellular connection. This may result in a substantial deterioration in the quality of communications.

There is a need then for a solution that overcomes the drawbacks of the known approaches. The present invention addresses this need.

### SUMMARY OF THE INVENTION

An object of the present invention is to propose a method and a device for automatically selecting a wireless access network for a mobile device.

Advantageously, the invention will be implemented in mobile terminals, such as smartphones, laptop computers or tablets, but also in mobile routers in the automotive sector and the sectors of public transport, security in the public domain, logistics, mobile robots or mobile industrial equipment, for example.

In order to obtain the desired results, a method, an apparatus and a computer program product are proposed.

In particular, a method for selecting, according to the location of a mobile device, a connection interface for connecting to a wireless access network, the mobile device being equipped with a plurality of connection interfaces, the method comprising the steps of:

identifying the access networks available at the location of the mobile device;

taking, for each connection interface of the mobile device, a plurality ‘n’ of measurements of the quality of the signals for each identified access network;

evaluating, for each connection interface, said ‘n’ measurements according to predefined evaluation criteria; and

comparing the results of the evaluations in order to select the connection interface having the best evaluation of the quality of the signal from among the plurality of connection interfaces of said mobile device.

In one preferred implementation, the step of evaluating the plurality ‘n’ of measurements is carried out according to at least three evaluation criteria. Advantageously, the criteria for evaluating the quality of the signal are at least threshold, instability and progress criteria.

The evaluation according to the threshold criterion consists of positioning a majority of the ‘n’ measurements with respect to predefined upper and lower thresholds. The evaluation according to the instability criterion consists of carrying out a calculation based on a standard deviation value of the ‘n’ measurements. The evaluation according to the progress criterion consists of determining a variation in the quality of the signal for the ‘n’ measurements.

In one embodiment, the step of comparing the evaluations additionally comprises a step of comparing the results of the evaluations with predefined user preferences. Advantageously, the predefined user preferences comprise connection priorities for connecting to access networks.

Advantageously, the available access networks belong to the group of WiFi access networks, 3G/4G cellular access networks, 802.11p access networks, satellite networks, private mobile radiocommunications (PMR) networks such as the TETRA/TETRAPOL network, for example. The connection interfaces of the mobile device belong to the group of WiFi, 3G/4G, 802.11p, satellite, PMR interfaces.

The invention also covers an apparatus that comprises means for selecting, according to the location of a mobile device, a connection interface for connecting to a wireless access network, the mobile device being equipped with a plurality of connection interfaces, the apparatus comprising means for implementing the steps of the method.

Advantageously, the method will be implemented in a mobile device of mobile terminal or mobile router type.

The invention may operate in the form of a computer program product that comprises code instructions allowing the steps of the claimed method to be carried out when the program is executed on a computer.

### BRIEF DESCRIPTION OF DRAWINGS

Various aspects and advantages of the invention will appear in support of the description of one preferred, but non-limiting, mode of implementation of the invention, with reference to the figures below:

FIG. 1 schematically shows an environment in which the invention may be implemented;

FIG. 2 is a schematic of the functional blocks for carrying out the method of the invention in one embodiment;

FIG. 3 illustrates a sequence of steps for evaluating available network access interfaces according to the method of the invention;

FIG. 4 details the steps of the decision-making method for evaluating a default interface in one embodiment of the invention.

### DETAILED DESCRIPTION OF THE INVENTION

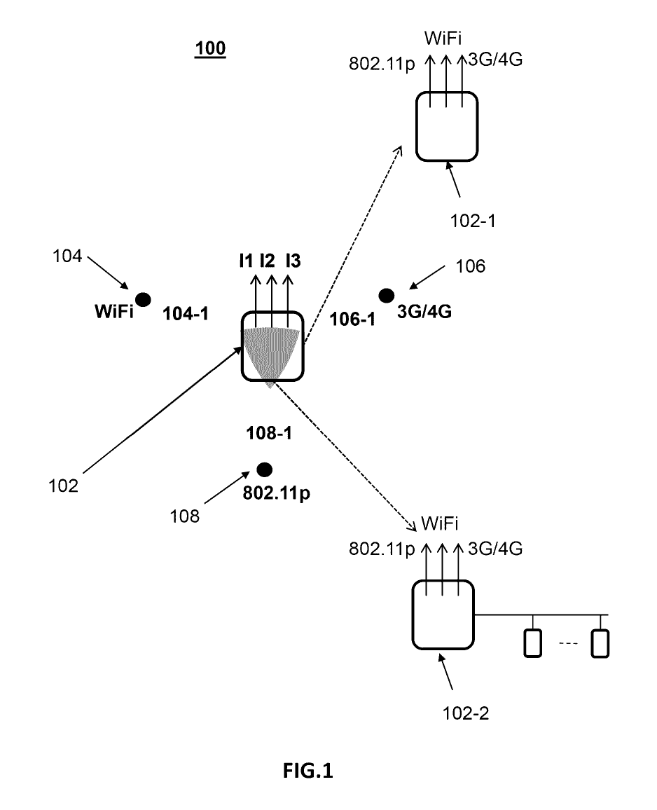

Reference is made to FIG. 1 which schematically shows an environment 100 in which the invention may advantageously be implemented. For reasons of clarity and simplicity, the description pertains to a single mobile device (102), but those skilled in the art will extend the described principles to a plurality of devices.

In the same manner, the description does not specify the nature of the mobile device, which may be either a mobile terminal (102-1) or a mobile router (102-2) such as shown in close-up in FIG. 1.

The mobile device is equipped with multiple connection interfaces for connecting to an access network, each potentially using one specific connection technology having different characteristics. Thus, in a non-limiting manner, three connection interfaces are illustrated: a WiFi interface (I1), a 3G/4G interface (I2) and an 802.11p interface (I3). Those skilled in the art will understand that the described principles are applicable regardless of the number and nature of connection interfaces (In).

The mobile device (102) may be equipped with a user interface, of screen or keyboard type for example if it is a mobile terminal, or be without a user interface if it is a mobile router.

The location in which a mobile device (102) is situated may be covered by one or simultaneously by multiple wireless access networks. FIG. 1 illustrates the case of three available access networks: a WiFi access network (104-1) via a WiFi hotspot (104), a cellular access network (106-1) via a 3G/4G base station (106) and a WAVE access network (108-1) via an 802.11p roadside unit (108).

Each network, which may overlap, has different conditions of use; for example, even if WiFi coverage overlaps with 4G cellular coverage in an outdoor park, the WiFi signal will potentially be very strong while the 4G signal will be very weak. Without the mechanism of the invention, a mobile device will attach each of its interfaces to one of the access networks that covers the location in which it is situated, even if the individual conditions of use are not optimum.

In general, the invention allows a mobile device to dynamically select an access network that is optimal for its connectivity, that is available in a particular location without the intervention of the user, using an automatic decision-making method based on predefined user preferences and on continuously taken measurements of the quality of the signals.

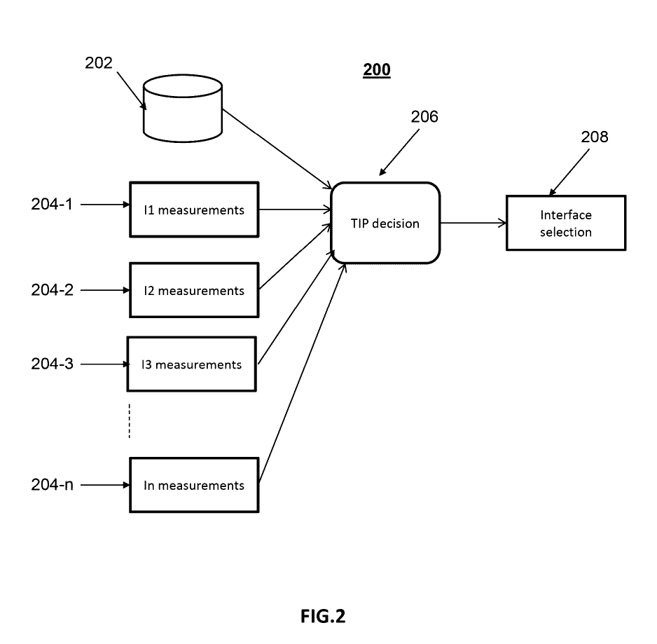

FIG. 2 schematically illustrates the apparatus (200) for carrying out the method of selecting a wireless access network according to one embodiment of the invention. The apparatus comprises a storage block (202) allowing user preferences to be given. Advantageously, the block is a static configuration file which allows a user to record the names of known networks, indicate their priority, and any other selection criteria such as parameters indicating upper, lower and majority thresholds which are taken into account by the process of the invention. Thus, a user will be able to predefine an order in which networks are selected, for example in descending order of priority: WiFi/4G/802.11p. It should be noted that the method of the invention also works in the absence of user preferences. The user preferences are stored in a configuration file, which, in the case of a mobile terminal with a user interface, may be regularly updated by the user, for example once a minute. In the case of a mobile router without a user interface, the user has the possibility to install a configuration file containing the preferences once the router is connected in a controlled environment and equipped with an external user interface (such as an external screen and keyboard). The installation or the updating of the configuration file containing the preferences may also be done remotely via a network connection. The mobile router reads the configuration file each time the router starts up or each time the file is remotely modified. Thus, typically, in the context of a mobile router on board a vehicle, the mobile router will take the user preferences into account each time the vehicle starts up or each time the preferences are remotely updated.

The apparatus also comprises a plurality of measurement blocks (204-1, 204-2, 204-n) capable of taking measurements of the signals corresponding to the available access networks. Each measurement block is coupled to a respective interface of the apparatus. Thus, for the example of FIG. 1, a first measurement block (204-1) coupled to the interface I1 allows readings of WiFi signals to be taken, a second measurement block (204-2) coupled to the interface I2 allows readings of 4G signals to be taken, and a third measurement block (204-3) coupled to the interface I3 allows readings of 802.11p signals to be taken.

The set of measurement blocks and user preferences is coupled to a decision-making block (206) which allows an evaluation process to be undertaken in which all of the parameters and measurements are taken into account. The output of the decision-making block (206) is coupled to a selection block (208) which allows the interface retained for the connection to the network to be selected and activated depending on the result of the evaluation.

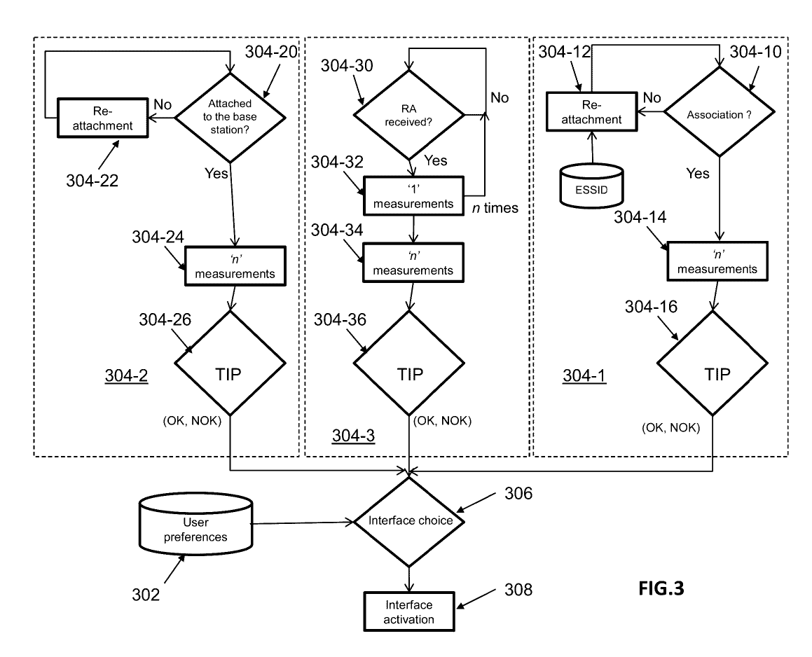

Reference is now made to FIG. 3, which illustrates a sequence of steps according to the method of the invention for evaluating the available network access interfaces in one embodiment corresponding to FIG. 2.

The block (304-1) details the steps for evaluating the quality of the signals over an interface of WiFi type. The interface may be a conventional interface with a beacon and be equipped with a list of names of networks with, potentially, access keys. The attachment to one of these networks is not detailed here and may be achieved using existing simple algorithms. In a first step (304-10), the method verifies the association of the interface with a network. If this is not the case, the method retrieves, from a preconfigured list, the name of the ESSID (service set identifier) network and reattaches the interface (304-12).

Once attached, the method allows (304-14) a set of ‘n’ measurements of the quality of the signal, referred to as last measurements, to be taken. The value of ‘n’ is independently parameterizable in the configuration file for each parameter to be evaluated (T, I and P). In one preferred embodiment, ‘n’ is set to 10, corresponding to a reading of the 10 last measurements. It should be noted that the larger ‘n’ is, the more correct the decision to toggle between interfaces is, in order to toggle to a network that actually offers better quality and without immediately switching back, thus avoiding “ping-pongs” or precipitous toggling. On the other hand, the larger ‘n’, the more time is required to take these measurements and thus toggling is less reactive, hence less efficient for certain applications, such as in vehicles for example. Over each type of link, it is possible to take a measurement at a predefined interval in time which is mainly dependent on the theoretical bandwidth of the respective link: for example, over an 802.11b WiFi link with a theoretical bandwidth of 11 Mbit/s, it is possible to take a measurement at an interval of a minimum of around 5 milliseconds.

In a following step (304-16), the method allows the last measurements taken to be evaluated for at least three “TIP” criteria, which are preferably threshold (T), instability (I) and progress (P) criteria. As will be described below, the evaluation mechanism, referred to as the “TIP” evaluation mechanism, is applied to each evaluated interface of the mobile device.

The evaluation step allows a validation (OK) or an invalidation (NOK) of the evaluated interface to be generated regarding its potential of use for communications. The result of the evaluation is delivered to the decision-making module (306).

The block (304-2) details the steps for evaluating the quality of the signals over an interface of 3G/4G cellular type. The cellular interface is characterized by a process of continuously connecting and attempting to reconnect in the event of loss of connectivity to a base station. Thus, a first step (304-20) consists of verifying whether the interface is attached to a base station, and reattaching (304-22) if necessary. This is advantageous in the case of leaving dark areas, for example for a mobile router in a vehicle leaving a tunnel and which is no longer covered by any network. Next, while the cellular interface is connected, the method allows the step (304-24) to take ‘n’ successive measurements of the quality of the signal, referred to as last measurements. Then, in a following step (304-26), the method allows these last measurements to be processed by the “TIP” evaluation method. The “TIP” evaluation produces a binary result, which validates (OK) or invalidates (NOK) the use of the cellular interface as a communication interface. The result of the evaluation is delivered to the decision-making module (306).

The block (304-3) details the steps for evaluating the quality of the signals over an interface of 802.11p type, for example. The interface may be an interface without a beacon and be characterized by the absence of a process of connecting to a base station and by the absence of the transmission of a beacon by the base station. A mobile router or terminal is therefore not able to measure the power of the signal from the base station. In order to solve this problem, the method allows, for this interface, a message of IPv6 router advertisement (RA) type (or an IPv4 router advertisement (RA) message) to be periodically sent by the “beaconless” base station. This allows the mobile router or terminal to evaluate the power of the signal on the basis of the reception of this message. Thus, a first step (304-30) consists of verifying the reception of an (RA) message, then successively taking ‘n’ measurements of the ‘n’ last (RA) messages received (step 304-32 looping ‘n’ times). When the ‘n’ measurements, referred to as ‘n’ last measurements, have been taken, the method moves on to the following step (304-36) in order to apply the “TIP” mechanism to these measurements for the purpose of obtaining a validation (OK) or invalidation (NOK) of the potential of using this interface for communication. The result of the evaluation is delivered to the decision-making module (306).

The method next (306) chooses the interface depending on the OK/NOK results obtained from each of the interfaces and by taking the user preferences (302) into account. Thus, if the WiFi interface, for example, is OK and all of the other interfaces have been invalidated (NOK), the method selects this interface. On the other hand, if multiple interfaces are simultaneously OK, the taking account of the user preferences allows the interface that is predefined in priority to be selected.

After selecting the optimum interface, the method allows, in the following step, the device to toggle to the new interface or to keep the current interface if the latter has been invalidated.

Thus, the “TIP” evaluation is independently carried out on each interface with the aim of providing an indication of the capacity of the respective interface to be used as the “default interface” of the mobile router or terminal.

Advantageously, the apparatus of the invention allows new measurements to be periodically taken for each interface. For each new measurement, the “TIP” mechanism re-evaluates the last OK or NOK suggestion by taking the ‘n−1’ last measurements into account, plus the new last measurement.

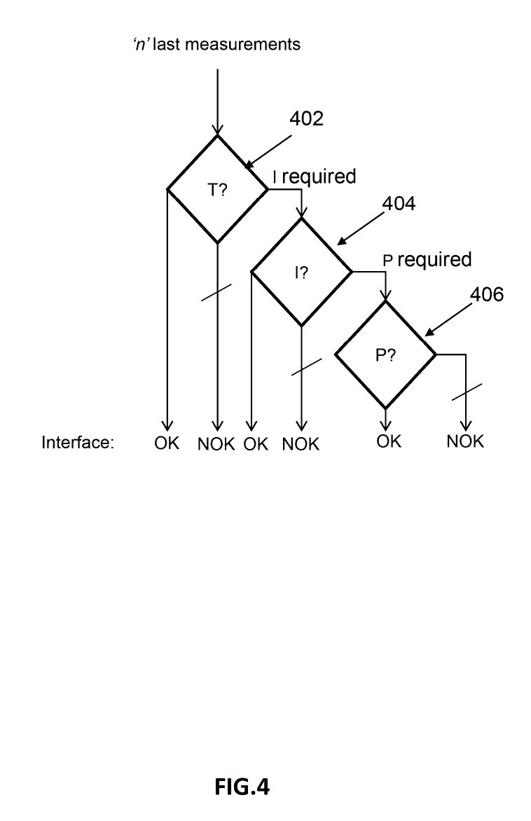

As mentioned, the “TIP” evaluation contains three successively evaluated criteria: the threshold criterion, the instability criterion and the progress criterion. FIG. 4 details the steps for evaluating the TIP criteria. In one embodiment, the criteria are evaluated in the order “T-I-P”, with the evaluation T of the threshold first (402), then the evaluation I of the instability (404) and lastly the evaluation P of the progress (406), this being the order allowing a correct result to be obtained in the fastest possible time. The evaluation T is relatively rough but responds quickly, while the evaluation I is hungrier in terms of computing time but its result is more frequently correct with respect to reality. The evaluation P is the fastest possible, in a single subtraction operation, but the result may be subject to errors. In alternative implementations, different evaluation orders, such as, for example, “P-I-T” or “I-P-T” are possible and constitute a parameter defined in the configuration file. On completion of the evaluation, the interface is proposed as having been validated (OK) or invalidated (NOK).

In a first step (402), the quality of the signal measured in the ‘n’ last measurements is evaluated with respect to the threshold criterion. Preferably, two thresholds are predefined: an upper threshold (Thigh) (for example: 80%), and a lower threshold (Tlow) (for example: 20%). A value, referred to as a “majority” value, is defined in order to carry out the evaluation of the ‘n’ measurements, for example equal to 60%. The evaluation of the threshold consists of positioning the majority of the ‘n’ last values of the measurements with respect to the predefined upper and lower thresholds. If the majority of the measurements is above the upper threshold, then the interface is declared to be validated (OK). If the majority of measurements is below the lower threshold, then the interface is declared to be invalidated (NOK).

If the evaluation of the interface on the basis of the above thresholds does not allow the interface to be declared valid (OK) or not valid (NOK), then the method moves on to the following step (404) in order to evaluate the second, instability criterion.

In one variant implementation, the evaluation of the threshold (T) is a strict evaluation, in which the two, upper and lower, thresholds have the same value, for example 70%. If the majority of the ‘n’ last measurements is located above the threshold, then the interface is declared OK, otherwise it is invalidated, it is not necessary to evaluate the other, instability and progress, criteria, and the interface is not retained.

Step (404) consists of evaluating the quality of the signal for the interface in question for the instability criterion, defined as follows. Initially, two threshold values are predefined in a configuration file: one major threshold value (for example 75%) and one minor threshold value (for example 40%). The method allows a standard deviation (sigma) value to be calculated for the ‘n’ last measurements, and a maximum possible standard deviation value (sigma_max) to be considered to be the maximum possible value of the signal level for this interface divided by two. The maximum possible value of the signal level for an interface is the maximum value that could be managed by a driver controlling the network card and allows the state of the network to be interrogated. Thus, for example, the maximum value could be 90 in the case of a cellular interface driver, and 70 in the case of a WiFi interface driver.

The evaluation according to the instability criterion consists of carrying out a calculation based on a standard deviation of the ‘n’ last measurements as follows: if the value of the standard deviation is higher than the percentage value of the major threshold of the maximum standard deviation (e.g. sigma>75% of sigma_max), it is considered that there is a lot of instability over the link, and the interface is not validated (NOK). If the value of the standard deviation is lower than the percentage value of the minor threshold of the maximum standard deviation (e.g. sigma<40% of sigma_max), it is considered that the link is relatively stable and the interface is validated (OK). If the value of the standard deviation is located between the two, major and minor, thresholds, the method moves on to the evaluation of the progress (P) criterion in step (406).

The evaluation according to the progress criterion consists of determining a variation in the quality of the signal for the ‘n’ last measurements as follows: the difference between the last (most recent) and the first (oldest) measurement from the ‘n’ last measurements is calculated. If this difference is positive, then it is considered that the interface is valid (OK), otherwise the interface is not validated (NOK).

The result of the evaluation of the TIP criteria for each interface is subsequently delivered to the decision-making module (306) in order to select the optimum interface, then activate the selected interface (308). Advantageously, the selected optimum interface is activated by configuring it as the “default” interface on the device (mobile router or terminal).

Thus, a method has been described that allows automatic toggling between networks of the same type (WiFi to WiFi for example), or between different networks, by selecting, at any time, the network providing the best connectivity in terms of quality of the signal and user preferences as the default network.

The mechanism described in this invention functions just as well in the presence of the configuration file containing the user preferences as in the absence of a configuration file. In the case in which the user has not expressed any preferences, such as in test configuration, or when exploring an unknown radio environment, or else for a mobile router being used by a plurality of users whose preferences are incompatible (e.g. in public transport), the mechanism operates as follows. If multiple interfaces are evaluated as OK by the “TIP” evaluation method, then the default interface is chosen according to three possible alternatives:

random choice according to a source of random data: a pseudo random number generator, for example, or the movement of mice on a user interface in the case of a mobile terminal, or high-precision sample temperature measurements or the timestamp on incoming packets in the case of a mobile router;

alternatively, a choice based on the intrinsic characteristics of radio technology (for example the interface whose nominal specifications have not been measured, but whose bandwidth, latency are superior, or for example using the 4G interface rather than the 802.11b interface as its bit rate is higher according to specifications);

alternatively, choosing the interface that was the last to be correctly attached to an access network.

Advantageously, the method functions without the intervention of the user besides preconfiguring parameters.

Major advantages of the present invention are:
the capability to deal with the non-uniformity of access networks;
operation with a variable number of network access interfaces;
operation without the intervention of the user over a user interface.

Thus, the described method allows the connectivity to the infrastructure of a mobile terminal or a mobile router to be made reliable, by continuously evaluating the quality of the connection of each of the interfaces of the mobile router or terminal and by changing the default interface used by communications when necessary. The selection method also allows all connectivity interruptions to be avoided while at least one of the interfaces is connected, while maximizing the quality of the service available for communications. Moreover, when it is combined with an IP mobility management protocol (Mobile IPv4, Mobile IPv6, NEMOv4, NEMOv6, PMIPv4, PMIPv6), the method of the invention allows applications to be kept running when toggling between interfaces and networks. For example, in the case in which the Mobile IPv6 protocol is used, the mobile router or terminal, after having selected a new interface, will have to send a message called a binding update, containing a care-of address containing the IPv6 address of the interface selected via TIP. This message is sent to a home agent which is a fixed router entity established at the core of the network, and which is responsible for redirecting data streams to the new attachment point of the mobile router or terminal.

Those skilled in the art will consider that the present invention may be implemented using hardware and/or software elements and be carried out on a computer. It may be available as a computer program product on a medium that can be read by computer. The medium may be electronic, magnetic, optical, electromagnetic or be a relay medium of infrared type. Examples of such media are semiconductor memories (random access memory RAM, read-only memory ROM), tapes, floppy disks or magnetic or optical disks (compact disk-read-only memory (CD-ROM), compact disk-read/write (CD-R/W) and DVD).

1. A method for selecting, according to the location of a mobile device, a connection interface for connecting to a wireless access network, the mobile device being equipped with a plurality of connection interfaces, the method comprising the steps of:
identifying the access networks available at the location of the mobile device;
continuously taking, for each connection interface of the mobile device, a plurality ‘n’ of successive measurements of the quality of the signals for each identified access network;
evaluating, for each connection interface, said ‘n’ successive measurements according to predefined evaluation criteria; and
comparing the results of the evaluations in order to select the connection interface having the best evaluation of the quality of the signal from among the plurality of connection interfaces of said mobile device.

2. The method as claimed in claim 1, wherein the step of evaluating the plurality ‘n’ of successive measurements is carried out according to at least three evaluation criteria.

3. The method as claimed in claim 1, wherein the criteria for evaluating the quality of the signal are at least threshold, instability and progress criteria.

4. The method as claimed in claim 3, wherein the evaluation according to the threshold criterion consists of positioning a majority of said ‘n’ successive measurements with respect to predefined upper and lower thresholds.

5. The method as claimed in claim 3, wherein the evaluation according to the instability criterion consists of carrying out a calculation based on a standard deviation value of said ‘n’ successive measurements.

6. The method as claimed in claim 3, wherein the evaluation according to the progress criterion consists of determining a variation in the quality of the signal for said ‘n’ successive measurements.

7. The method as claimed in claim 1, wherein the comparison step additionally comprises a step of comparing the results of the evaluations with predefined user preferences.

8. The method as claimed in claim 7, wherein the predefined user preferences comprise connection priorities for connecting to access networks.

9. The method as claimed in claim 1, wherein the available access networks belong to the group of WiFi access networks, 3G/4G cellular access networks, 802.11p access networks.

10. The method as claimed in claim 1, wherein the connection interfaces of the mobile device belong to the group of WiFi, 3G/4G, 802.11p interfaces.

11. An apparatus for selecting, according to the location of a mobile device, a connection interface for connecting to a wireless access network, the mobile device being equipped with a plurality of connection interfaces, the apparatus comprising means for implementing the steps of the method as claimed in claim 1.

12. A mobile device comprising an apparatus as claimed in claim 11.

13. The apparatus as claimed in claim 11, wherein the mobile device is a mobile terminal or a mobile router.

14. A computer program product, said computer program comprising code instructions allowing the steps of the method as claimed in claim 1 to be carried out, when said program is executed on a computer.
